(19) United States
(12) Patent Application Publication
(10) Pub. No.: US 2009/0123093 A1
(43) Pub. Date: May 14, 2009

(54) BAG WITH REINFORCED HANDLES AND PROCESS OF MAKING THE BAG

(75) Inventors: CLAUDE LEMOYNE, SAINT-JEAN-SUR-RICHELIEU (CA); SYLVAIN DESILETS, LONGUEUIL (CA); JONATHAN LE SAGE, SHEFFORD (CA); PAUL GELINAS, BROMONT (CA)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: EMBALLAGE ROUVILLE INC., MARIEVILLE, QC (CA)

(21) Appl. No.: 12/043,475

(22) Filed: Mar. 6, 2008

Related U.S. Application Data
(60) Provisional application No. 60/996,347, filed on Nov. 13, 2007.

(51) Int. Cl. B65D 33/24; B65D 33/10; B31B 1/84

(52) U.S. Cl. 383/99; 383/9; 493/213

(57) ABSTRACT

There is described a bag for being manipulated by a lifting element, including a tube portion defined by at least two opposed side walls and two opposed end sections. The first end section closes the tube portion for defining a cavity and the second end section includes at least one flap extending from one of the side walls to be connected to the other side wall. There is a slot defined beneath and parallel to the flap in between the opposed side walls for receiving the lifting element, the flap and the slot thereby defining a handle. There is also one or more reinforcement members, such as a strip of HDPE or the like, each applied to and extending between the flap and the corresponding side wall. The reinforcement strip resists tearing of the handle when the bag is lifted.

### FIELD OF THE INVENTION

The present invention generally relates to the field of packaging and more specifically to the field of bags for containing, storing, and/or transporting material.

### BACKGROUND OF THE INVENTION

In the packaging industry, there are many different types of bags for containing material. Bag construction depends on a variety of factors, including the weight and type of material to be contained as well as the filling method. Bags may have one or more layers, flat bottoms, gussets, pasted valves and/or an open mouth.

Various types of prior art bags are the “Pasted Valve Stepped End” (PVSE), the “Pasted Open Mouth” (POM) and the “Pasted Open Mouth Pinch Bottom” (POMPB) bags. The PVSE, POM and POMPB bags present some difficulties in taking hold of the bags with one's hands to pick up and manipulate them, especially when the contents have an elevated weight such as about 25 to 40 Kg or a large volume. The traditional PVSE and POM bags are therefore often supported underneath when they are manipulated, which may decrease the efficiency of manual or automated manipulation.

Prior art PVSE bags may be provided with a space at the top of the bag, between the infold panel and the overlapping flaps to insert the valve. However, this space is not designated for inserting a hand to attempt to pick up the bag. This location is often weak and if pulled upon may result in small or large tears, which render the bag susceptible to subsequent tear propagation, or complete tearing of the overlapping flaps or bag walls. These tears often occur at the corner fold between the flap, the infold panel and the side wall and propagate inwardly due to shear forces.

In prior art PVSE bags, the valve is located between an overlapping flap and an infold panel. The valve of a PVSE bag enables material to be blown, conveyed or screwed into the bag, and is particularly useful when the material is susceptible to dust dispersion or scattering such as concrete or cement. For such materials, PVSE bags are often used, since the filling is performed by an endless screw or by blowing. For instance, the exit of the endless screw or the blowing tube is secured within the valve of the PVSE bag, and the material is screwed or blown within the bag, therefore limiting dispersion and excessive waste of the material.

In various filling methods and in other applications, it may be desirable to be able to lift and manipulate the filled bags by hand, for instance to unload the bags from a filling unit or stack the bags in a certain fashion.

The prior art also includes other types of bags, such as the “Pasted Bottom Open Mouth” (PBOM) and the “Sewn Open Mouth” (SOM) bags. These bags may also present difficulties in terms of lifting and manipulating. So-called “Open Mouth” bags are most often filled by gravity and this method of filling is not ideal for all products, for instance in the case of powdered cement. For such products, PVSE bags are often used, as was mentioned above. SOM bags may be provided with a valve that is glued on by hand, which is an inefficient process, to enable it to be filled by endless screw or blowing.

The prior art presents various deficiencies in terms of providing a bag that is cost-effective, has efficient manufacturability, and may be efficiently manipulated and lifted. There is indeed a need for a bag that overcomes at least one of the disadvantages of the prior art.

### SUMMARY OF THE INVENTION

The present invention responds to the above-mentioned need by providing a bag for receiving contents and being manipulated by a lifting element, such as a users hands. The present invention also responds to this need by providing a process for manufacturing such a bag.

Accordingly, the present invention provides a bag for receiving contents and being manipulated by a lifting element. The bag includes a tube portion defined by at least two opposed side walls. The bag also includes two opposed end sections, the first end section closing the tube portion for defining a cavity for receiving the contents, the second end section having at least one flap extending from one of the side walls to be connected in relation to the other of the side walls. At least one slot is defined beneath and parallel to the flap in between the opposed side walls for receiving the lifting element. The flap and the slot thereby define a handle. The bag also includes at least one reinforcement member, each being applied to and extending between the at least one flap and the corresponding side wall.

In an optional embodiment of the bag of the present invention the first and second end sections are respectively bottom and top sections. Optionally, the at least one flap includes two overlapping flaps, each extending from a respective one of the side walls and being secured together in an overlapping configuration. Also optionally, the slot includes two opposed slots located at opposite lateral sides of the two overlapping flaps. Also optionally, each reinforcement member includes two opposed reinforcement strips, each applied to a respective one of the two overlapping flaps and the corresponding side wall. Optionally, the two opposed reinforcement strips overlap at the two overlapping flaps and the two opposed reinforcement strips extend down the entire height of the corresponding side walls. It is also optional that the tube portion further includes lateral walls joining the opposed side walls, and each reinforcement member further includes a lateral portion applied to the lateral walls and joining the two opposed reinforcement strips. The at least one reinforcement member may include two pairs of reinforcement strips, each pair being arranged in spaced relation on a respective one of the overlapping flaps and the corresponding side wall. Also, each reinforcement strip may be located at a respective lateral edge of the corresponding flap. Optionally, each reinforcement strip of one pair is aligned with a respective reinforcement strip of the opposing pair and each reinforcement strip of one pair overlaps with a respective one of the opposing pair at the overlapping flaps.

Also optionally, the side walls, the bottom section and the top section are formed from a web. The web may be formed so as to comprise the tube portion with opposed ends, each of the opposed ends having opposed corners, each of the corners being scored with diagonal scores to provide inwardly folded infold panels and the overlapping flaps. The overlapping flaps at the bottom section may be folded and glued to close the bottom section. The infold panels at the corners of the top section may be spaced apart to provide an inlet opening in fluid communication with the cavity of the bag, and the overlapping flaps at the top section may be folded and glued so as to provide a valve opening between the overlapping flaps and at least one of the infold panels.

Optionally, a valve sleeve arranged and glued within the valve opening.

Also optionally, the web includes multiple superimposed offset plies and is formed into a pasted valve stepped end bag. The multiple superimposed plies may include an inner ply in contact with the contents and a neighbouring ply having inward and outward facing surfaces, the at least one reinforcement member being provided on the inward facing surface of the neighbouring ply. The multiple superimposed plies may also include an outer ply. Optionally, each flap of the outer and neighbouring ply is defined between two corner slits to form rectangular-shaped flaps and each flap of the inner ply is defined between inward corner folds to form trapezoid-shaped flaps. Also optionally, each of the at least one reinforcement member is strip-shaped and is glued or applied directly to the corresponding flap and side wall.

According to an optional aspect of the invention, the opposed side walls and the at least one flap are composed of a paper material, and each reinforcement member is composed of a reinforcing material enabling a greater tear resistance than the paper material. Optionally, the reinforcing material is a flexible polymer applied in sufficient thickness to avoid stretching thereof beyond a maximum elongation of the paper material and/or beyond a permanent deformation threshold of the flexible polymer, when the bag is loaded with the contents and lifted via the handle. In one embodiment, the reinforcement material is HDPE, which may have a thickness of about 0.005 inches.

The present invention also provides a process for making a bag including the steps of
a) providing a web;
b) applying at least one reinforcement member on the web;
c) forming the web to have a tube portion with at least two opposed side walls;
d) providing a closed bottom section and a top section at opposite ends of the tube portion, so that the top section comprises at least one flap extending from one of the side walls to be connected in relation to the other of the side walls, a slot is defined beneath and parallel to the flap and in between the opposed side walls, the flap and the slot thereby defining a handle, and the reinforcement member extends between the at least one flap and the corresponding side wall.

In an optional embodiment of the process of the present invention, in step d) the at least one flap includes two overlapping flaps, each extending from a respective one of the side walls, and further including step e) of securing the flaps together in an overlapping configuration.

Optionally, in step d) the at least one slot includes two opposed slots located at opposite lateral sides of the two overlapping flaps.

Optionally, in step b) each reinforcement member is applied to the web so as to form in step d) two opposed reinforcement strips each extending between a respective one of the two overlapping flaps and the corresponding side wall.

Also optionally, in step d) the two opposed reinforcement strips overlap at the two overlapping flaps.

Optionally, in step c) the tube portion further includes lateral walls joining the opposed side walls, and in step b) each reinforcement member is applied so that in step d) each reinforcement member further includes a lateral portion located at the lateral walls and joining the two opposed reinforcement strips.

Optionally, in step b) the at least one reinforcement member includes two reinforcement members applied to the web in spaced relation so that in step d) each reinforcement strip is in spaced relation with one of the reinforcement strips of the other reinforcement member, to form a pair of reinforcement strips on each overlapping flap and corresponding side wall.

Optionally, in step d) each reinforcement strip is located at a respective lateral edge of the corresponding flap.

Optionally, in step d) each reinforcement strip of one pair is aligned with a respective reinforcement member of the opposing pair.

Optionally, in step d) each reinforcement strip of one pair overlaps with a respective one of the opposing pair at the overlapping flaps.

Optionally, in step d) the tube portion has opposed ends, each of the opposed ends have opposed corners, each of the corners are scored with diagonal scores to provide inwardly foldable infold panels and the overlapping flaps, the overlapping flaps at the bottom section are folded and glued to provide a closed bottom, the infold panels at the corners of the top section are spaced apart to provide an inlet opening in fluid communication with the cavity of the bag, the overlapping flaps at the top section are folded and glued so as to provide a valve opening between the overlapping flaps and at least one of the infold panels.

Optionally, the process also includes the step f) of arranging and gluing a valve sleeve within the valve opening.

Optionally, in step a) the web includes multiple superimposable offset plies and in step f) the bag is made into a pasted valve stepped end bag. The web may also include multiple superimposable plies. The multiple superimposable plies provided in step a) may include an inner ply and a neighbouring ply having an inner surface in contact with the inner ply, and wherein in step b) the at least one reinforcement member is provided on the inward facing surface of the neighbouring ply. The multiple superimposable plies may include an outer ply.

Also optionally, in step b) each of the at least one reinforcement member is strip-shaped and is glued or applied directly to the web.

According to one embodiment, the web is composed of a paper material and each reinforcement member is composed of a reinforcing material enabling a greater tear resistance than the paper material. The reinforcing material may be a flexible polymer applied in sufficient thickness to avoid stretching thereof beyond a maximum elongation of the paper material when the bag is loaded with contents and lifted via the handle.

According to one optional aspect of the invention, the reinforcement material is a polyethylene-based material. The polyethylene-based material may be HDPE and it may be applied in a thickness of about 0.005 inches.

The above process enables an efficient way of manufacturing a bag with a reinforced handle.

### BRIEF DESCRIPTION OF THE DRAWINGS

FIGS. 1a and 1b are perspective top semi-transparent views of embodiments of the bag of the present invention.

FIGS. 2a and 2b are perspective top semi-transparent views of the embodiment of the reinforcement member of the bag of FIG. 1a.

FIGS. 3a and 3b are perspective top views of the embodiment of the reinforcement member of the bag of FIG. 1b.

FIG. 4 is a perspective cut semi-transparent view of a bottom corner of an embodiment of the bag according to the present invention.

FIG. 5 is a perspective cut semi-transparent view of a top corner of an embodiment of the bag according to the present invention.

FIGS. 6a-6c are side plan views of the top of an embodiment of the bag of the present invention, showing folding and gluing steps.

FIG. 7 is a plan flat view of a web to be used in forming an embodiment of the bag of the present invention.

FIG. 8 is a plan flat view of a web to be used in forming another embodiment of the bag of the present invention.

FIG. 9 is a side plan view of the top of another embodiment of the bag of the present invention.

### DETAILED DESCRIPTION OF THE PREFERRED EMBODIMENT

The present invention includes a bag and a process of making the same. The bag includes a reinforcement member to prevent the tearing of the bag when it is lifted or manipulated by its handle.

It should be noted that the invention may be used in connection with a variety of different types of bags in order to reinforce the handles to facilitate lifting and manoeuvring.

### Embodiments of the Bag

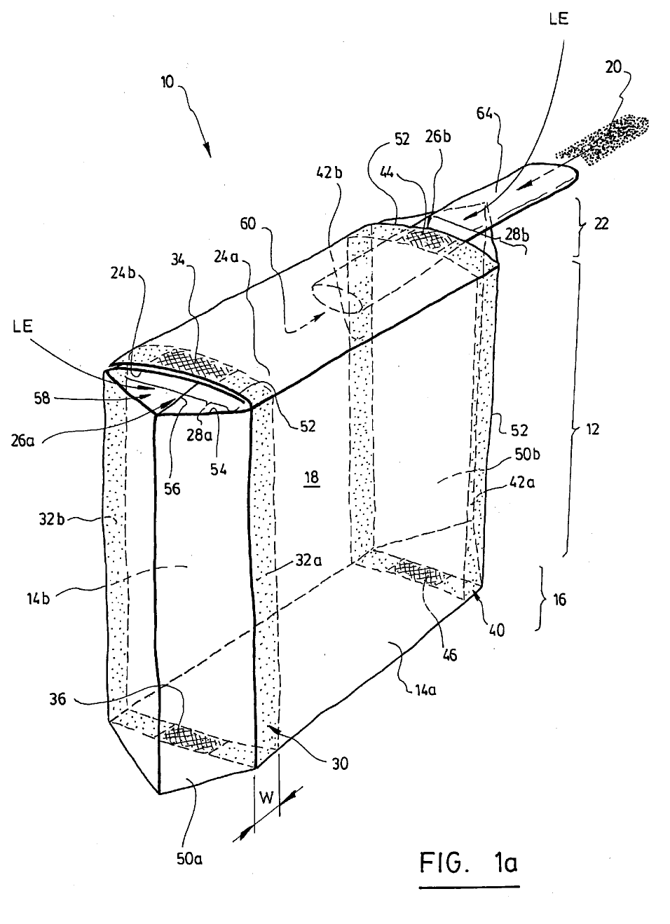

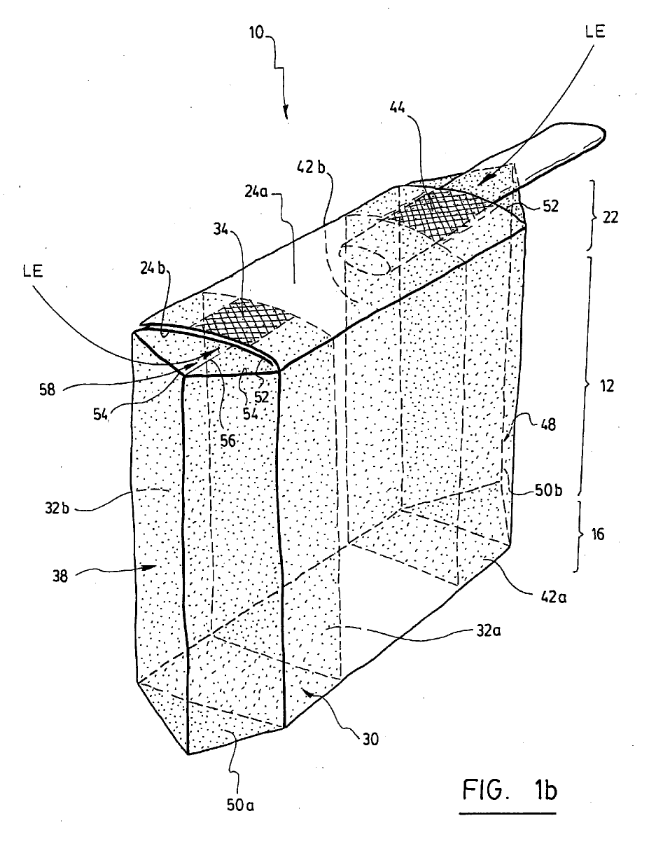

FIGS. 1a, 2a, 2b, 6a-6c and 9 illustrate a bag 10 or parts of the bag according to a first embodiment.

FIGS. 1b, 3a, 3b, 4 and 5 illustrate a bag 10 or parts of the bag according to a second embodiment.

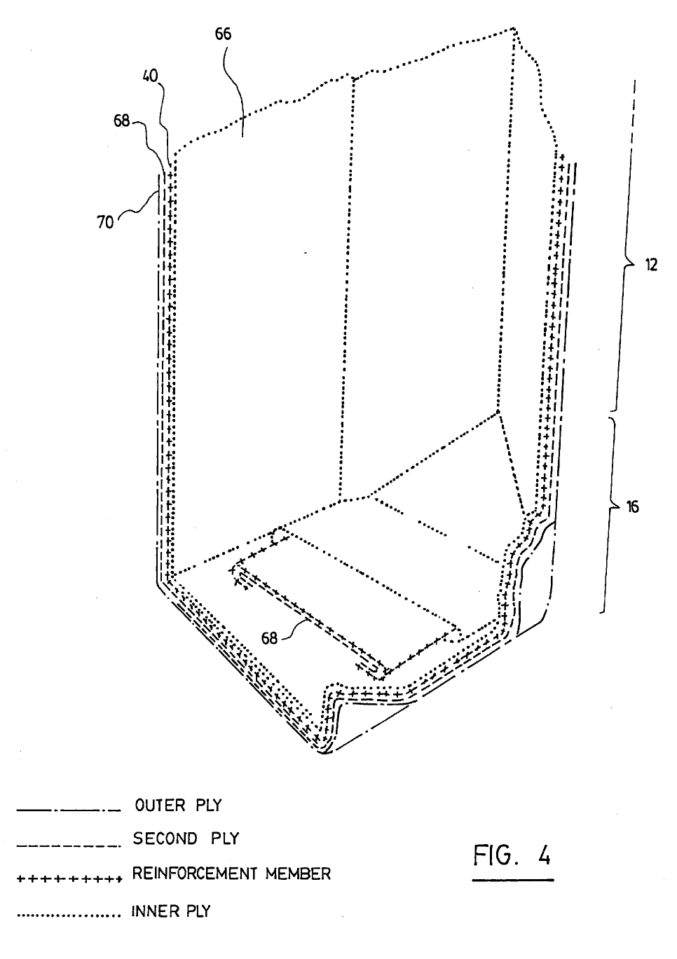

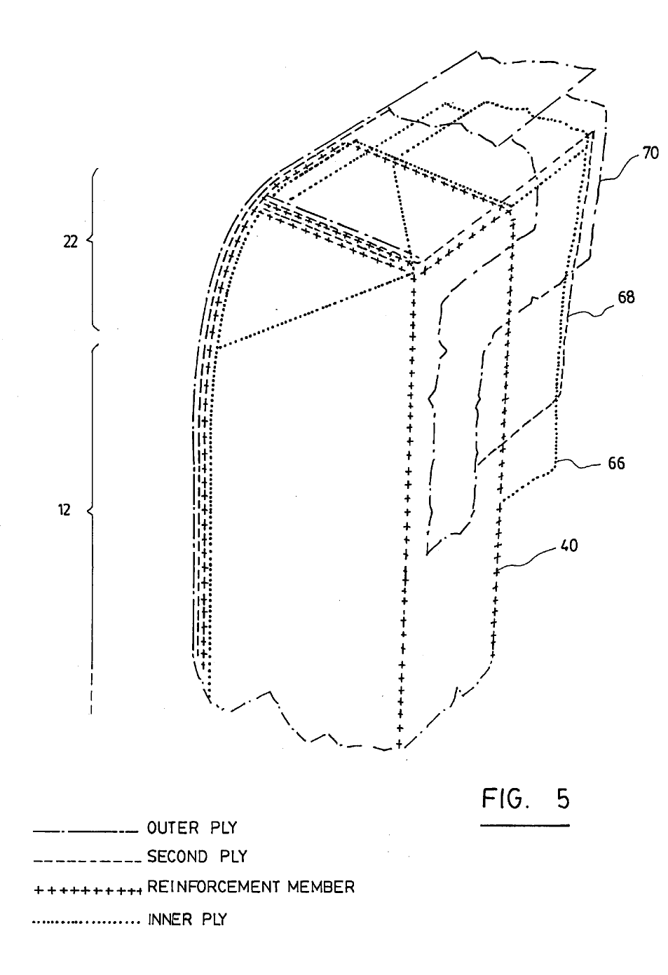

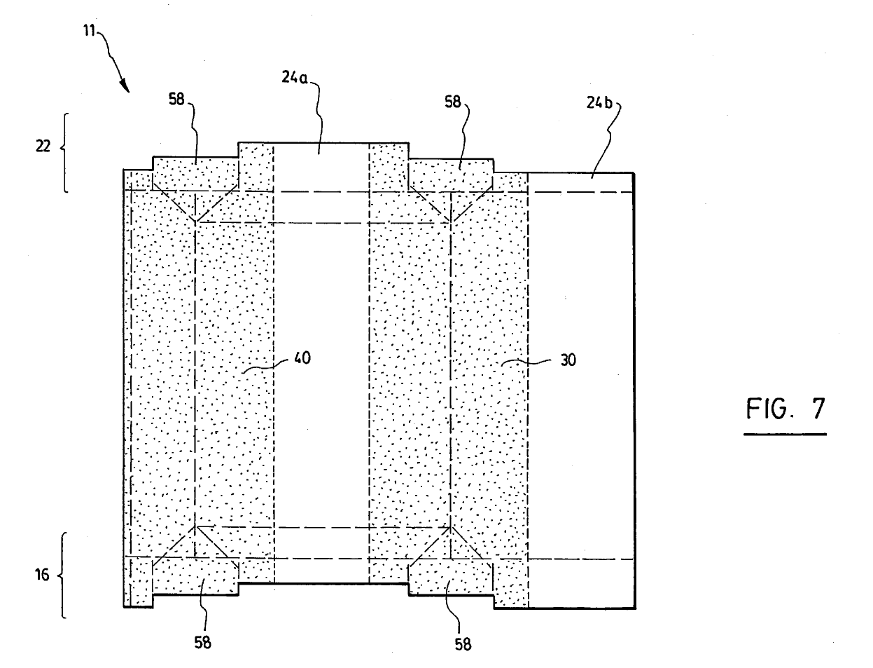

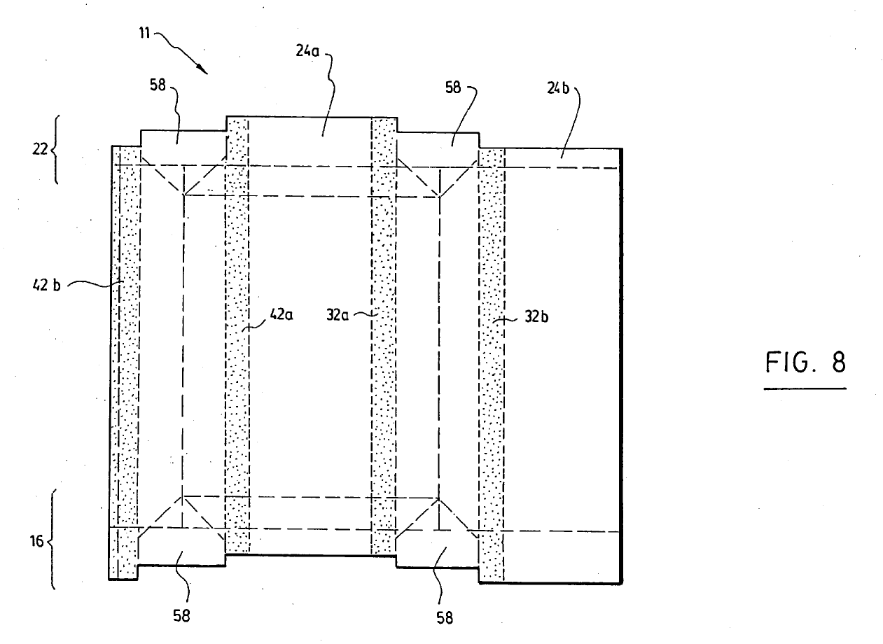

In a preferred aspect of the invention, the bag is formed from a web 11, examples of which are illustrated in FIGS. 7 and 8. The web 11 preferably includes multiple superimposed plies, more about which will be discussed hereinbelow in relation to FIGS. 4 and 5.

Referring now to FIG. 1a, the first embodiment of the bag 10 includes a tube portion 12 defined by at least two opposed side walls 14a,14b. The bag 10 also includes a bottom section 16 closing the tube portion 12 for defining a cavity 18 for receiving the contents 20. The bag 10 also includes a top section 22 including two overlapping flaps 24a,24b extending from respective side walls 14a,14b. It should be understood that the bag 10 may alternatively have one flap extending from one of the side walls to be connected to the other of the side walls.

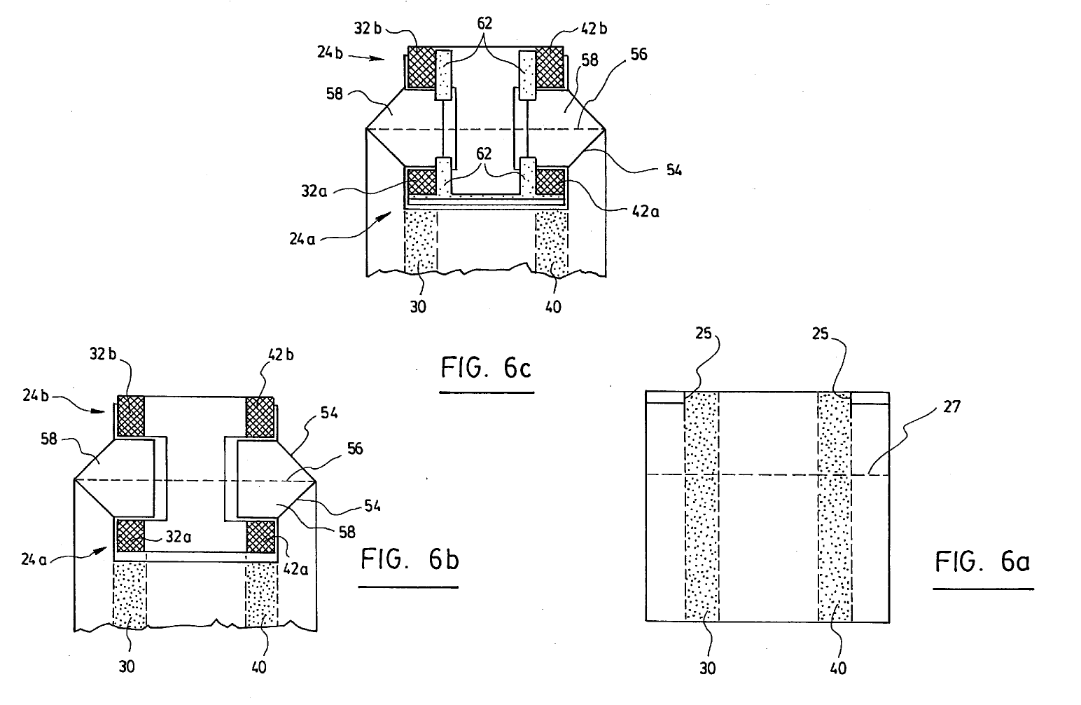

Referring now to FIGS. 6a-6c, the flaps 24a may be formed by cutting slits 25 in the top section 22. Also, a main score 27 may be provided to enable a good overlap of the flaps 24a,24b when they are glued together. The slits 25 define and delimit the width of the flaps 24a,24b and infold panels (which are also called “edge slits” and will be described further hereinbelow). By cutting slits, it is possible to provide rectangular flaps and to increase the gluing surface available.

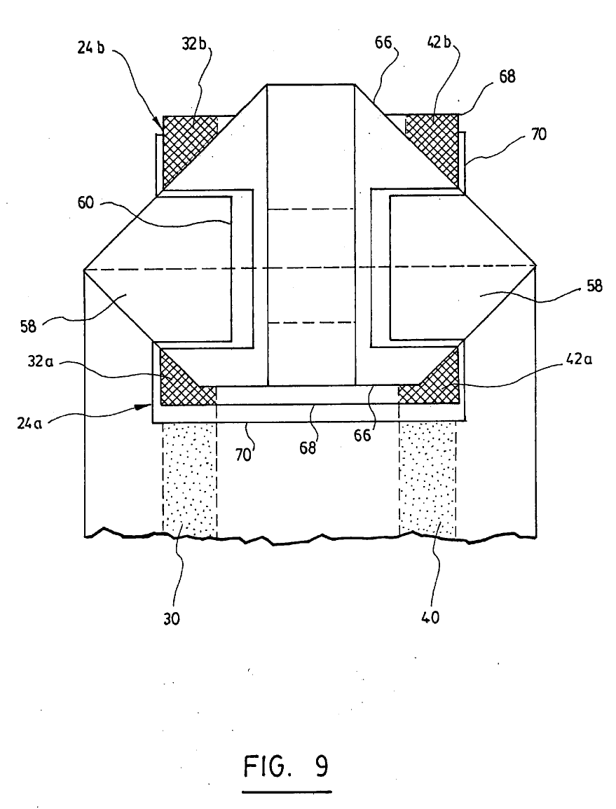

Alternatively, as illustrated in FIG. 9 for one of the plies, there may be no slits and the flaps may be formed by folding the sides inwardly. Such flaps, instead of having a rectangular shape, would be trapezoid shaped as illustrated. More regarding this embodiment, particularly in relation to the multiple plies of the bag, will be further discussed hereinbelow.

Referring to FIG. 1a, this embodiment of the bag 10 also includes two opposed slots 26a,26b, which are defined beneath and parallel to the flaps 24a,24b in between the opposed side walls 14a,14b. The slots 26a,26b have dimensions enabling a lifting element LE to be inserted therein. The slots 26a,26b combined with the flaps 24a,24b thus define handles 28a,28b for manipulating the bag 10. It should be understood that one slot may be provided on one side of the bag, to form a single handle. The two opposed handles 28a,28b enable balanced lifting of the bag 10 and increased weight distribution to decrease the likelihood of tearing.

The bag 10 further includes two reinforcement members 30,40 each being applied to the flaps 24a,24b and side walls 14a,14b. It should be noted that there may be one reinforcement member applied to one of the flaps and extending down the corresponding side wall from which the flap extends. The reinforcement members 30,40 reinforce the intersection between the flaps 24a,24b and the side walls 14a,14b and in the region of the handles 28a,28b. Thus, when a user inserts their hands as lifting elements LE into the slots 26a,26b and lifts upward, the reinforcement members 30,40 resist inward tearing of the flaps 24a,24b and the side walls 14a,14b.

In a preferred aspect of the bag 10, as illustrated in FIG. 1a, each reinforcement member 30,40 includes two opposed reinforcement strips. Thus, the reinforcement member 30 has strips 32a,32b that are applied to respective overlapping flaps 24a,24b and side walls 14a,14b. The reinforcement member 40 has strips 42a,42b that are also applied to respective overlapping flaps 24a,24b and side walls 14a,14b. Referring to one of the reinforcement members 30, preferably the two opposed reinforcement strips 32a,32b overlap at the two overlapping flaps 24a,24b in an overlapping region 34. For the other reinforcement member 40 the overlapping region is indicated by 44. In this embodiment, each reinforcement member 30,40 includes two strips and therefore the opposed reinforcement strips 32a,32b and 42a,42b extend down the corresponding side walls 14a,14b, and may overlap each other at the bottom section 16 in a bottom overlap regions 36,46. The overlapping may be contiguous or not and may take on a variety of arrangements. Preferably, the opposed strips 32a,32b each extend to the corresponding end edge of the flaps 24a,24b, to increase the size of the overlapping region 34 and the strength of the handle 28a.

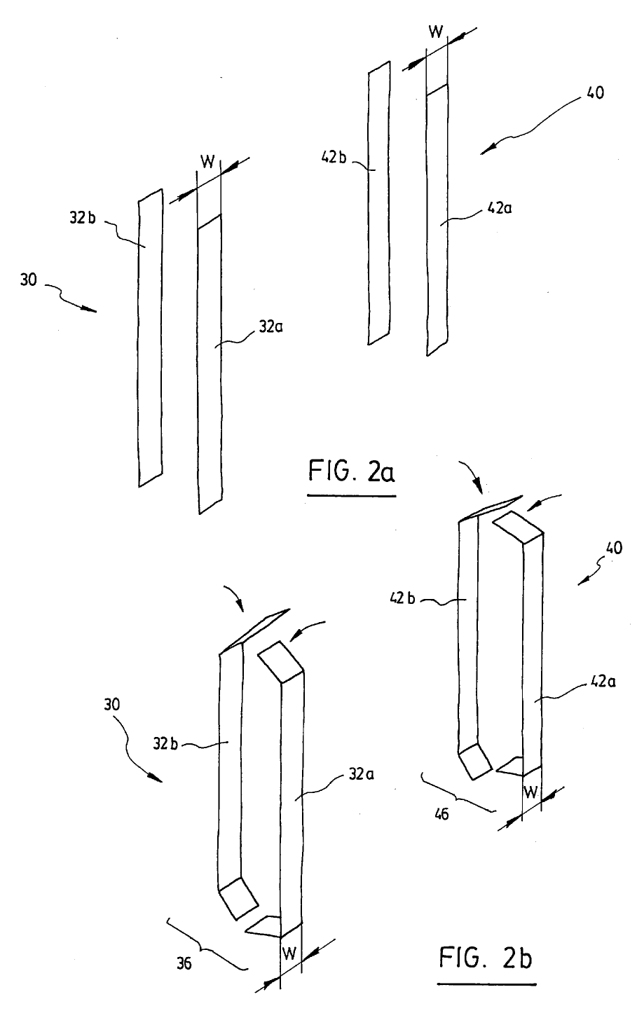

FIGS. 2a and 2b illustrate the reinforcement members 30,40 in isolation. Referring to reinforcement member 30 in particular, the top ends of the opposed strips 32a,32b fold inward, since they are applied to the overlapping flaps of the bag (not illustrated here), when the flaps are overlapped and glued together.

Referring now to FIG. 1b, which illustrates the second embodiment, the reinforcement members 30,40 also include lateral portions 38,48. Accordingly, the tube portion 12 further includes lateral walls 50a, 50b joining the opposed side walls 14a,14b, and the opposed reinforcement strips 32a,32b and 42a,42b of each reinforcement member 30,40 are joined around the lateral walls 50a,50b by the lateral portions 38,48.

Referring to FIGS. 1a and 1b, the reinforcement members 30,40 include two pairs of reinforcement strips 32a,42a and 32b,42b. Each pair is arranged in spaced relation on a respective one of the overlapping flaps 24a,24b and the corresponding side walls 14a,14b. Preferably, each reinforcement strip 32a,32b,42a,42b is located at a respective lateral edge 52 of the corresponding flap. This may enable increased reinforcement at the location where tears would tend to begin at the top corners of the bag 10, when upward forces are exerted on the handles 28a,28b. This also ameliorates resisting tear propagation.

The two pairs of strips arranged in this way may enable a symmetrical reinforcement of the width of the bag and symmetrical reinforcement of the depth of the bag. In such embodiments, there is an improved reinforcement on various sides of the bag.

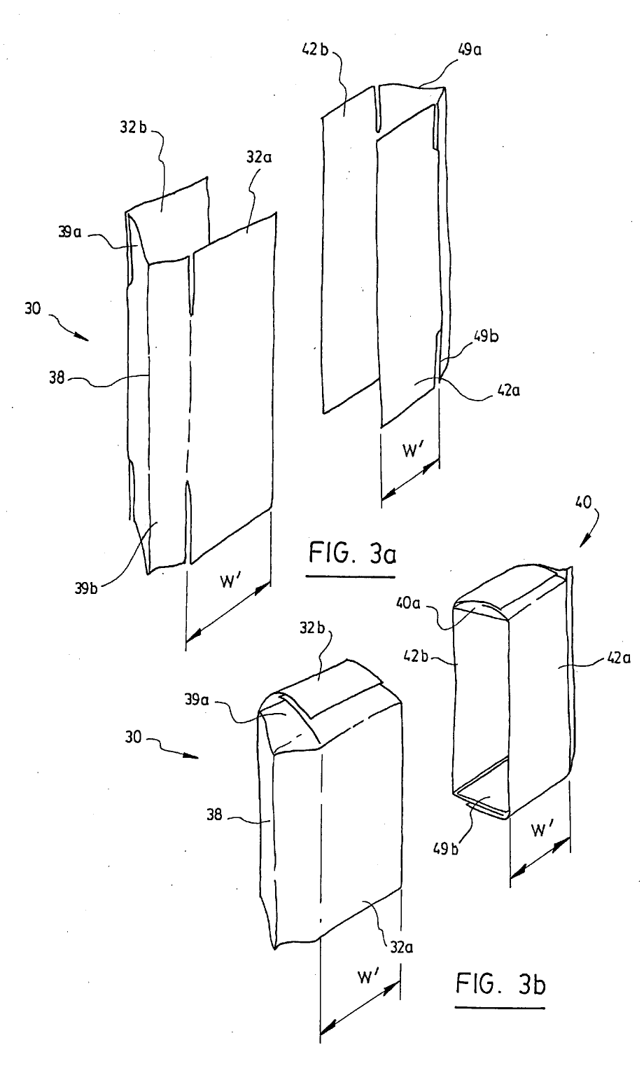

FIGS. 3a and 3b illustrate the reinforcement members 30,40 of the second embodiment in isolation. Referring to reinforcement member 30 in particular, the top ends of the opposed strips 32a,32b fold inward, as they are secured to the overlapping flaps of the bag (not illustrated here). In addition, the lateral portion 38 includes top and bottom ends 39a,39b that fold inward and beneath the top ends of the opposed strips 32a,32b.

Referring now to FIGS. 1a and 1b, the bag is optionally formed from a web (character 11 in FIG. 7) that is provided with scores and folds to form the bag 10. The web is thus formed into the tube portion 12 with opposed ends, each of the opposed ends having opposed corners, each of the corners being scored with diagonal scores 54 and side scores 56 to provide inwardly folded infold panels 58 and the overlapping flaps 24a,24b.

By locating the strips 32a,32b,42a,42b at least partly at the top corners of the bag 10—which in the case of PVSE type bags is where the flaps 24a,24b meet the infold panels 58 and the opposed side walls 14a,14b—the top corners of the bag are reinforced to resist vertical tensile forces as well as shear forces inwardly along the folded flaps 24a,24b, when the bag 10 is lifted or manipulated by a user. This strategic location may also enable an increased efficiency of the use of the strips' material and allow the strips to be efficiently applied.

Overlapping flaps may also be located at the bottom section 16, and are folded and glued to close the bottom section 16. FIG. 4 illustrates part of a closed bottom section 16.

Referring back to FIGS. 1a and 1b, the infold panels 58 at the corners of the top section 22 are spaced apart to provide an inlet opening 60 in fluid communication with the cavity 18 of the bag 10.

FIGS. 6b and 6c also illustrate the inlet opening 60.

Referring still to FIGS. 6b and 6c, the overlapping flaps 24a,24b at the top section 22 are folded and glued so as to provide a valve opening between the overlapping flaps 24a,24b and at least one of the infold panels 58. Preferably, a glue pattern 62 is applied on the underside of the flaps 24a,24b as shown in FIG. 6c. The glue pattern preferably extends the entire width of the top flap 24a and also in inward strips on the top and bottom flaps 24a,24b. This glue pattern 62 enables a decrease in glue surface and allows for a preferred embodiment of the slots (illustrated as 26a,26b is FIGS. 1a and 1b) to be formed beneath the glued flaps 24a,24b. Such slots may facilitate the insertion of the hands of a user for manipulating the bag 10. It should be noted that different glue patterns may also be applied in a predetermined fashion in order to allow a lifting element of a particular design to be received therein with increased fit and efficiency.

Referring briefly back to FIG. 1b, the top and bottom ends 39a,39b of the lateral portion 38 are applied to the part of the web that will be formed into infold panels 58. Thus the infold panels 58 may also be covered with the reinforcement material.

In a preferred aspect of the bag 10, a valve sleeve 64 is arranged and glued within the valve opening. The valve may be glued to the infold panel to be beneath the corresponding slot and/or may be glued to the flap to be above the corresponding slot.

In another preferred aspect of the bag, the web to form the bag includes multiple superimposed offset plies and is formed into a pasted valve stepped end (PVSE) bag. The web may include two, three or more superimposed plies, more about which will be discussed hereinbelow.

Referring now to FIG. 5, showing other preferred aspects of the bag, the multiple superimposed plies include an inner ply 66 in contact with the contents (not illustrated here) and also includes a neighbouring ply 68 (also referred to as a “second ply”) having inward and outward facing surfaces. The reinforcement member 30 is optionally provided on the inward facing surface of the second ply 68. This may enable the lifting element to directly contact the reinforcement member 30 when inserted into the slot 26a, which may decrease the tear formation and propagation of the flaps 24a,24b. This may also enable the reinforcement member(s) to be hidden from view to ameliorate aesthetics and facilitate printing on the visible surfaces of the bag.

Still referring to FIG. 5, there is also an outer ply 70. Preferably, before forming the bag, the plies 66,68,70 are superimposed and offset to so that when various elements such as the overlapping flaps and infold panels are formed and glued together the strength of the bond is increased. An example of such overlapping is illustrated in FIGS. 6a-6c.

Referring to FIGS. 1a and 1b, another preferred aspect of the bag is that the opposed side walls 14a,14b and the flaps 24a,24b are composed of a paper material, and each reinforcement member is composed of a reinforcing material enabling a greater tear resistance than the paper material. Also preferably, the reinforcing material is a flexible polymer applied in sufficient width W,W′ and thickness (as illustrated in FIGS. 1a-3b) to avoid stretching thereof beyond a maximum elongation of the paper material when the bag is loaded with the contents and lifted via the handle. The reinforcement material may be a polyethylene-based material, such as HDPE. It should be noted that the properties of the reinforcing material may be tailored depending, for instance, on the material of the flaps and side walls, on the weight of the bag when lifted via the handles and/or on the method of lifting the bag.

It should be indeed understood that a variety of alternative materials may be used. For instance, the strips 32a,32b,42a,42b may be thick or thin and composed of polymeric or other materials, preferably those that are flexible. The strips 32a,32b,42a,42b and the handles are composed of materials having properties and dimensions such that the strips 32a,32b,42a,42b may sufficiently reduce and preferably prevent the strain of the handle past a critical tearing threshold. Preferably, the strips 32a,32b,42a,42b prevent tearing of the flaps 24a,24b and side walls 14a,14b when the bag 10 is filled with about 25 Kg of product, and still preferably when it is filled with about 45 Kg of product, or more. It is also preferable that if the flaps 24a,24b or side wall 14a,14b undergo a small tear, the reinforcement strips 32a,32b,42a,42b are capable of preventing inward propagation of the tear.

The strips 32a,32b,42a,42b are thus arranged and chosen in such a manner as to increase the resistance to tearing when the bag 10 is lifted or manipulated by its handles 28a,28b. The strips 32a,32b,42a,42b preferably extend the entire height of the bag 10 and thus resist tension forces when the bag 10 is lifted. In addition, the strips 32a,32b,42a,42b resist shear forces where the flaps 24a,24b meet the side walls 14a,14b when the bag 10 is lifted. The strips 32a,32b,42a,42b may also allow for safer lifting of the bag and reduce the likelihood of paper cuts from the paper flap material, for instance when arranged at the lateral edges of the flaps. In addition, the strips 32a,32b,42a,42b are easily applied during one of the first steps of production of the bag 10 by an automated process, more of which will be discussed hereinbelow.

Also preferably, the HDPE strips 32a,32b,42a,42b are provided so as to not strain past their permanent deformation threshold when the bag 10 is lifted or manipulated, and thereby prevent tearing of the paper over an extended period of time. The dimensions and properties of the strips' materials may also be modified in accordance with the desired weight of the bag 10 and its contents.

Furthermore, the strips 32a,32b,42a,42b are preferably composed of thick HDPE because of its stiffness (relatively high Young's modulus). The HDPE preferably supports most of the tensile force exerted by lifting the bag 10 without stretching beyond the maximum elongation of the paper extended to rupture (stretch %). The stretch is often between about 2% and 8%.

Furthermore, it was found that a three-ply bag was sufficiently reinforced in the handle region by using strips 32a,32b,42a,42b of HDPE of 0.005 inches thick to avoid tearing under heavy loads in the order of 45 Kg.

Referring now to FIG. 7, an example of how the reinforcement members 30,40 may be applied on the web 11 is illustrated. This embodiment may enable increased efficiency and simplicity of applying the reinforcement members on the web and increased reinforcement of various areas of the bag.

Referring now to FIG. 8, another example of how reinforcement strips 32a,32b,42a,42b may be applied on the web 11 is illustrated. Here, instead of only two reinforcement members being applied, four distinct reinforcement strips 32a,32b,42a,42b are applied to the web 11, so that when the web 11 is folded and glued the embodiment of the bag 10 of FIG. 1 may be formed. This embodiment may enable a decreased amount of reinforcement material to be used and/or increased precision of the reinforcement, for instance.

Referring to FIG. 9, in a preferred embodiment of the bag, slits (such as those shown as 25 in FIG. 6a) are provided in the second and outer plies, so that these plies can form rectangular flaps, but no slits are provided in the inner ply. Therefore, the inner ply is folded inwardly to form trapezoid shaped flaps as illustrated. This provides an advantage of making the inner ply more sift proof, in other words reducing the risk of the bag's content leaking out the sides around the slots, during filling and/or manipulation of the bag. By providing slits in the outer plies and no slits in the inner ply, the bag is more sift proof and also displays an increased gluing surface for securing the flaps together. In addition, the folded inner ply with no slit may offer an increase in tear resistance.

In operation, the bag 10 as illustrated in FIG. 1a, once filled with contents 20 may be manipulated by a user. For instance, a user may insert their hands in the opposing slots 26a,26b and grip the flaps 24a,24b. The hands may then act as the lifting elements LE to lift upward on the flaps 24a,24b to lift and manipulate the bag 10, for stacking, moving, etc. It should also be understood that other types of lifting elements, such as automatic mechanical elements, may also be used to lift the bag 10.

In some applications, the bag may be filled or lifted by the bottom section and thus the flaps and reinforcement members may be also be arranged at the bottom section of the bag to form the handle at that location. In such cases, the lifting element could be inserted into the bottom slots and manipulated sideways or lifted. The bottom handles may be reinforced to improve resistance to inward tearing of the flaps and side walls. Optionally, there are reinforced handles at the top and bottom of the bag.

It should also be noted that the preferred embodiment of the bag is a PVSE type bag, but it may alternatively be a POM type bag or another type of bag having a flap extending between two side walls to be reinforced by a reinforcement member in the manner of the invention.

### Embodiments of the Process

Referring to FIGS. 7 and 8, the bag is preferably made from a web 11 by the steps described hereinbelow.

Step a) includes providing the web 11, which may have a variety of forms but preferably is flat and provided with pre-cut flaps. Preferably, the web 11 is made of paper. At this point, the web is preferably substantially flat to facilitate application of the strips thereon. It should be understood that the preferred embodiment has three superimposed plies (not illustrated in FIGS. 7 and 8), which have predetermined dimensions and are offset relative to one another to improve the overlap of the folded parts and thus the overall strength of the bag.

Step b) includes applying at least one reinforcement member 30,40, which may comprise various reinforcement strips 32a,32b,42a,42b, on the web 11. This is preferably done by gluing the strips 32a,32b,42a,42b, especially when they are composed of HDPE or an equivalent material, onto the paper layer. This is preferably an automated process performed by a gluing unit. Each HDPE strip is preferably applied in sufficient thickness and width to provide good resistance to tearing of the web material, which is preferably paper. In the preferred embodiment having three superimposed plies, this step b) is preferably performed on the second ply 68 only, particularly on its surface which will be inward facing. Being on the middle layer may enable preventing any contact between the contents of the bag and the strips. Alternatively, in some cases, the strips may be applied on one of the other layers on the inward or outward facing surface thereof. The strips may alternatively be directly applied to the web, for instance by laminating and/or thermal application.

The strip-shaped nature of the reinforcement member facilitates the application thereof during one of the early steps of the bag's production, preferably by an automated process, and enables an efficient use of material.

Step c) includes assuring that the web 11 has a tube portion 12 with at least two opposed side walls 14a,14b. On the one hand, if the strips 32a,32b,42a,42b were applied to the web while it was still flat, then the web should be subsequently formed into a tubular shape. On the other hand, if the web was already in tubular form when the strips 32a,32b,42a,42b were applied, then step d) may be performed straight away. In the preferred embodiment, the “tubular” shape does not have gussets, since a PVSE bag is to be made.

Step d) includes providing the closed bottom section 16 and the top section 22 at opposite ends of the tube portion 12, so that the top section 22 comprises at least one flap 24a,24b extending from one of the side walls 14a to be connected in relation to the other of the side walls 14b. Step d) also includes providing a slot 26a that is defined beneath and parallel to the flap 24a and in between the opposed side walls 14a,14b so that the flap 24a and the slot 26a define the handle 28a. Step d) also includes providing the reinforcement member 30 so that it extends between the at least one flap 24a and the corresponding side wall 14a.

Preferably, the process of making the bag has various additional steps—such as folding, scoring, gluing, cutting, etc.—to form one of the preferred embodiments of the bag as shown in the Figs.

However, it should be understood that different types of bags may be manufactured and thus additional or modified steps may be included to provide certain features, such as gussets, valves, additional folds, etc.

It should be understood that the embodiments of the present invention are put forth here as examples only and do not limit what has actually being invented. Many modifications can be made to these embodiments without departing from what has actually been invented.

1. A bag for receiving contents and being manipulated by a lifting element, the bag comprising:
a tube portion defined by at least two opposed side walls,
two opposed end sections, the first end section closing the tube portion for defining a cavity for receiving the contents;
the second end section comprising at least one flap extending from one of the side walls to be connected in relation to the other of the side walls, at least one slot being defined beneath and parallel to the flap in between the opposed side walls for receiving the lifting element, the flap and the slot thereby defining a handle;
at least one reinforcement member, each being applied to and extending between the at least one flap and the corresponding side wall.

2. The bag of claim 1, wherein the first and second end sections are respectively bottom and top sections.

3. The bag of claim 2, wherein the at least one flap comprises two overlapping flaps, each extending from a respective one of the side walls and being secured together in an overlapping configuration.

4. The bag of claim 3, wherein the at least one slot comprises two opposed slots located at opposite lateral sides of the two overlapping flaps.

5. The bag of claim 3, wherein each reinforcement member comprises two opposed reinforcement strips, each applied to a respective one of the two overlapping flaps and the corresponding side wall.

6. The bag of claim 5, wherein the two opposed reinforcement strips overlap at the two overlapping flaps.

7. The bag of claim 6, wherein the two opposed reinforcement strips extend down the entire height of the corresponding side walls.

8. The bag of claim 7, wherein the tube portion further comprises lateral walls joining the opposed side walls, and wherein each reinforcement member further comprises a lateral portion applied to the lateral walls and joining the two opposed reinforcement strips.

9. The bag of claim 3, wherein the at least one reinforcement member comprises two pairs of reinforcement strips, each pair being arranged in spaced relation on a respective one of the overlapping flaps and the corresponding side wall.

10. The bag of claim 9, wherein each reinforcement strip is located at a respective lateral edge of the corresponding flap.

11. The bag of claim 10, wherein each reinforcement strip of one pair is aligned with a respective reinforcement strip of the opposing pair.

12. The bag of claim 11, wherein each reinforcement strip of one pair overlaps with a respective one of the opposing pair at the overlapping flaps.

13. The bag of claim 3, wherein the side walls, the bottom section and the top section are formed from a web.

14. The bag of claim 13, wherein the web is formed so as to comprise the tube portion with opposed ends, each of the opposed ends having opposed corners, each of the corners being scored with diagonal scores to provide inwardly folded infold panels and the overlapping flaps, the overlapping flaps at the bottom section being folded and glued to close the bottom section, the infold panels at the corners of the top section being spaced apart to provide an inlet opening in fluid communication with the cavity of the bag, and the overlapping flaps at the top section being folded and glued so as to provide a valve opening between the overlapping flaps and at least one of the infold panels.

15. The bag of claim 14, further comprising a valve sleeve arranged and glued within the valve opening.

16. The bag of claim 15, wherein the web comprises multiple superimposed offset plies and is formed into a pasted valve stepped end bag.

17. The bag of claim 13, wherein the web comprises multiple superimposed plies.

18. The bag of claim 17, wherein the multiple superimposed plies comprise an inner ply in contact with the contents and a neighbouring ply having inward and outward facing surfaces, the at least one reinforcement member being provided on the inward facing surface of the neighbouring ply.

19. The bag of claim 18, wherein the multiple superimposed plies further comprises an outer ply.

20. The bag of claim 19, wherein each flap of the outer and neighbouring ply is defined between two corner slits to form rectangular-shaped flaps and each flap of the inner ply is defined between inward corner folds to form trapezoid-shaped flaps.

21. The bag of claim 2, wherein each of the at least one reinforcement member is strip-shaped and is glued or applied directly to the corresponding flap and side wall.

22. The bag of claim 21, wherein the opposed side walls and the at least one flap are composed of a paper material, and each reinforcement member is composed of a reinforcing material enabling a greater tear resistance than the paper material.

23. The bag of claim 22, wherein the reinforcing material is a flexible polymer applied in sufficient thickness to avoid stretching thereof beyond a maximum elongation of the paper material and/or beyond a permanent deformation threshold of the flexible polymer, when the bag is loaded with the contents and lifted via the handle.

24. The bag of claim 23, wherein the reinforcement material is HDPE.

25. The bag of claim 24, wherein the reinforcement member made of HDPE has a thickness of about 0.005 inches.

26. A process for making a bag, comprising the steps of:
a) providing a web;
b) applying at least one reinforcement member on the web;
c) forming the web to have a tube portion with at least two opposed side walls;
d) providing a closed bottom section and a top section at opposite ends of the tube portion, so that the top section comprises at least one flap extending from one of the side walls to be connected in relation to the other of the side walls, a slot is defined beneath and parallel to the flap and in between the opposed side walls, the flap and the slot thereby defining a handle, and the reinforcement member extends between the at least one flap and the corresponding side wall.

27. The process of claim 26, wherein in step d) the at least one flap comprises two overlapping flaps, each extending from a respective one of the side walls, and further comprising step e) of securing the flaps together in an overlapping configuration.

28. The process of claim 27, wherein in step d) the at least one slot comprises two opposed slots located at opposite lateral sides of the two overlapping flaps.

29. The process of claim 27, wherein in step b) each reinforcement member is applied to the web so as to form in step d) two opposed reinforcement strips each extending between a respective one of the two overlapping flaps and the corresponding side wall.

30. The process of claim 29, wherein in step d) the two opposed reinforcement strips overlap at the two overlapping flaps.

31. The process of claim 30, wherein in step c) the tube portion further comprises lateral walls joining the opposed side walls, and in step b) each reinforcement member is applied so that in step d) each reinforcement member further comprises a lateral portion located at the lateral walls and joining the two opposed reinforcement strips.

32. The process of claim 29, wherein in step b) the at least one reinforcement member comprises two reinforcement members applied to the web in spaced relation so that in step d) each reinforcement strip is in spaced relation with one of the reinforcement strips of the other reinforcement member, to form a pair of reinforcement strips on each overlapping flap and corresponding side wall.

33. The process of claim 32, wherein in step d) each reinforcement strip is located at a respective lateral edge of the corresponding flap.

34. The process of claim 33, wherein in step d) each reinforcement strip of one pair is aligned with a respective reinforcement member of the opposing pair.

35. The process of claim 34, wherein in step d) each reinforcement strip of one pair overlaps with a respective one of the opposing pair at the overlapping flaps.

36. The process of claim 27, wherein in step d) the tube portion has opposed ends, each of the opposed ends have opposed corners, each of the corners are scored with diagonal scores to provide inwardly foldable infold panels and the overlapping flaps, the overlapping flaps at the bottom section are folded and glued to provide a closed bottom, the infold panels at the corners of the top section are spaced apart to provide an inlet opening in fluid communication with the cavity of the bag, the overlapping flaps at the top section are folded and glued so as to provide a valve opening between the overlapping flaps and at least one of the infold panels.

37. The process of claim 36, further comprising the step f) of arranging and gluing a valve sleeve within the valve opening.

38. The process of claim 37, wherein in step a) the web comprises multiple superimposable offset plies and in step f) the bag is made into a pasted valve stepped end bag.

39. The process of claim 26, wherein in step a) the web comprises multiple superimposable plies.

40. The process of claim 39, wherein the multiple superimposable plies provided in step a) comprise an inner ply and a neighbouring ply having an inner surface in contact with the inner ply, and wherein in step b) the at least one reinforcement member is provided on the inward facing surface of the neighbouring ply.

41. The process of claim 40, wherein in step a) the multiple superimposable plies further comprise an outer ply.

42. The process of claim 26, wherein in step b) each of the at least one reinforcement member is strip-shaped and is glued or applied directly to the web.

43. The process of claim 42, wherein the web is composed of a paper material and each reinforcement member is composed of a reinforcing material enabling a greater tear resistance than the paper material.

44. The process of claim 43, wherein the reinforcing material is a flexible polymer applied in sufficient thickness to avoid stretching thereof beyond a maximum elongation of the paper material when the bag is loaded with contents and lifted via the handle.

45. The process of claim 44, wherein the reinforcement material is a polyethylene-based material.

46. The process of claim 45, wherein the polyethylene-based material is HDPE.

47. The process of claim 46, wherein in step b) the HDPE reinforcement member is applied in a thickness of about 0.005 inches.
